(19) United States
(12) Patent Application Publication
(10) Pub. No.: US 2011/0058157 A1
(43) Pub. Date: Mar. 10, 2011

(54) METHOD OF HELPING PARTICLE DETECTION, METHOD OF PARTICLE DETECTION,APPARATUS FOR HELPING PARTICLE DETECTION,AND SYSTEM FOR PARTICLE DETECTION

(75) Inventors: Shigeru Kawamura, Yamanashi (JP); Teruyuki Hayashl, Yamanashi (JP)

(73) Assignee: Tokyo Electron Limited, Tokyo (JP)

(21) Appl. No.: 12/919,090

(22) PCT Filed: Jan. 20, 2009
(86) PCT No.: PCT/JP2009/050759

§ 371 Date: Nov. 29, 2010

(30) Foreign Application Priority Data
Feb. 25, 2008 (JP) 2008 042716

(51) Int. Cl. G01N 21/47; G01N 21/33; G01N 37/00

(52) U.S. Cl. 356/51; 73/28.01; 356/337

(57) ABSTRACT

A method of helping particle detection and a method of particle detection include an adsorption/infiltration step where an organic gas is brought into contact with organic particles to cause an organic gas component to be adsorbed and infiltrate to the organic particles; a foaming step where a heated gas is brought into contact with the organic particles contacted with the organic gas to foam/expand the organic particles; and an organic-particle detection step where the foamed/expanded organic particles are irradiated with light and light scattered by the organic particles is received to detect the organic particles. Further, the methods include an oxidation step where inorganic particles and the organic particles are oxidized to decompose the organic particles and expand the inorganic particles; and an inorganic particle detection step where the expanded inorganic particles are irradiated with light and light scattered by the inorganic particles is received to detect the inorganic particles.

### FIELD OF THE INVENTION

The present invention relates to a particle detection helping method for helping detection of organic or inorganic particles by selectively expanding the organic or the inorganic particles causing defects of semiconductors in a semiconductor manufacturing process, a particle detection method using the particle detection helping method, a particle detection helping apparatus and a particle detection system for performing the above methods, respectively.

### BACKGROUND OF THE INVENTION

When particles peeled off from an inner wall of a semiconductor manufacturing chamber are adhered to a surface of a semiconductor wafer, short circuit in wiring of semiconductor devices occurs and a production yield of the semiconductor devices decreases. Therefore, it is required to detect particle generation, e.g., the number of particles, the sizes of particles and the like, in a semiconductor manufacturing process. As for a method for detecting particles, there is used a light scattering method for detecting particles by irradiating light to the particles and measuring the amount of light scattered by the particles.

Further, semiconductor devices are highly miniaturized, and a currently processed line width reaches a level smaller than 50 nm. Moreover, a processing technique for line width of 30 nm is expected to be established in a near future. However, a light scattering technique capable of detecting particles smaller than or equal to 30 nm have not yet been developed. Accordingly, the relationship between a product yield and particles in that scale could not be discussed, and the product yield of semiconductor devices may decrease without having such technique.

Meanwhile, in order to improve light scattering detection accuracy, there is proposed a particle detection method capable of detecting finer particles by improving an intensity of light scattered from particles by adhering water droplets to particles on a semiconductor wafer (see, e.g., Patent Document 1).

Patent Document 1: Japanese Patent Application Publication No. H5-340885

However, the particle detection method disclosed in Patent Document 1 suffers from a drawback that the number of particles could not be accurately detected. This is because when a laser beam for light scattering is irradiated to the particles, the water droplets adhered to the particles are evaporated immediately.

### SUMMARY OF THE INVENTION

In view of the above, it is an object of the present invention to provide a particle detection helping method for foaming and expanding organic particles to accurately detect fine organic particles that could not be detected by a conventional light scattering method, a particle detection method that uses the particle detection helping method to detect organic particles more accurately compared to a conventional particle detection method, and a particle detection helping apparatus and a particle detection system for performing the above methods, respectively.

It is another object of the present invention to provide a particle detection helping method for foaming and expanding organic particles and oxidizing and expanding inorganic particles to accurately detect fine organic and inorganic particles that could not be detected by a conventional light scattering method, a particle detection method which uses the particle detection helping method to detect organic and inorganic particles more accurately compared to a conventional particle detection method, a particle detection helping apparatus and a particle detection system for performing the above methods, respectively.

It is still another object of the present invention to provide a particle detection helping method for oxidizing and expanding inorganic particles to accurately detect fine inorganic particles that could not be detected by a conventional light scattering method, a particle detection method which uses the particle detection helping method to detect inorganic particles more accurately compared to a conventional particle detection method, a particle detection helping apparatus and a particle detection system for performing the above methods, respectively.

It is still another object of the present invention to provide a particle detection method capable of detecting finer organic particles by effectively foaming and expanding organic particles.

It is still another object of the present invention to provide a particle detection method capable of detecting finer inorganic particles by effectively oxidizing and expanding inorganic particles.

In accordance with a first aspect of the present invention, there is provided a particle detection helping method for helping detection of organic particles by selectively expanding, among organic and inorganic particles causing defects of semiconductors in a semiconductor manufacturing process, the organic particles, the method including: an adsorption and infiltration step in which an organic gas component is adsorbed and infiltrated into the organic particles by bringing the organic gas into contact with the organic particles; and a foaming step in which the organic particles are foamed and expanded by heating the organic particles contacted with the organic gas.

In accordance with a second aspect of the present invention, the particle detection helping method described above further includes, after the foaming step, an oxidation step in which the inorganic and the organic particles are oxidized to thereby decompose the organic particles and expand the inorganic particles.

In accordance with a third aspect of the present invention, there is provided a particle detection helping method for helping detection of inorganic particles by selectively expanding, among organic and inorganic particles causing defects of semiconductors in a semiconductor manufacturing process, the inorganic particles, the method including an oxidation step in which the inorganic and the organic particles are oxidized to thereby decompose the organic particles and expand the inorganic particles.

In accordance with a fourth aspect of the present invention, there is provided a particle detection method for detecting organic particles by selectively expanding among organic and inorganic particles causing defects of semiconductors in a semiconductor manufacturing process, the organic particles, the method including: an adsorption and infiltration step in which an organic gas component is adsorbed and infiltrated into the organic particles by bringing the organic gas into contact with the organic particles; a foaming step in which the organic particles are foamed and expanded by heating the organic particles contacted with the organic gas; and an organic-particle detection step in which the foamed and expanded organic particles are irradiated with light and light scattered by the organic particles is received to thereby detect the organic particles.

In accordance with a fifth aspect of the present invention, in the particle detection method, the organic particles are heated by bringing a heated gas into contact with the organic particles contacted with an organic gas or by irradiating heating light to the organic particles in a nitrogen gas atmosphere in the foaming step.

In accordance with a sixth aspect of the present invention, in the particle detection method, a temperature of the organic particles in the adsorption and infiltration step is lower than a boiling point of the organic gas.

In accordance with a seventh aspect of the present invention, in the particle detection method, the particle detection method described above further includes, after the organic-particle detection step, an oxidation step in which the organic and the inorganic particles are oxidized to thereby decompose the organic particles and expand the inorganic particles; and an inorganic-particle detection step in which the expanded inorganic particles are irradiated with light and light scattered by the inorganic particles is received to thereby detect the inorganic particles.

In accordance with an eighth aspect of the present invention, in the particle detection method, there is provided a particle detection method for detecting inorganic particles by selectively expanding, among organic and inorganic particles causing defects of semiconductors in a semiconductor manufacturing process, the inorganic particles, the method including: an oxidation step in which the organic particles and the inorganic particles are oxidized to thereby decompose the organic particles and expand the inorganic particles; and an inorganic-particle detection step in which the expanded inorganic particles are irradiated with light and light scattered by the inorganic particles is received to thereby detect the inorganic particles.

In accordance with a ninth aspect of the present invention, in the particle detection method, the organic and the inorganic particles are oxidized by irradiating UV rays of the excimer lamp to the organic and the inorganic particles in an atmosphere of a gaseous mixture of oxygen and nitrogen in the oxidation step.

In accordance with a tenth aspect of the present invention, there is provided a particle detection helping apparatus for helping detection of organic particles by selectively expanding, among organic and inorganic particles causing defects of semiconductors in a semiconductor manufacturing process, the organic particles, the apparatus including: one or more processing chambers, each for accommodating a detection target object having organic and inorganic particles; an organic gas supply line for supplying an organic gas into one of the processing chambers; an organic gas supply valve for opening and closing the organic gas supply line; a heated gas supply line for supplying a heated gas into one of the processing chambers; a heated gas supply valve for opening and closing the heated gas supply line; and a control unit for controlling opening and closing of the organic gas supply valve and the heated gas supply valve so as to sequentially open the organic gas supply valve, close the organic gas supply valve and open the heated gas supply valve in that order.

In accordance with an eleventh aspect of the present invention, the particle detection helping apparatus described above further includes a UV lamp for irradiating UV rays to the detection target object, wherein the control unit turns on the UV lamp after closing the heated gas supply valve.

In accordance with a twelfth aspect of the present invention, the particle detection helping apparatus described above further includes: an oxidizing gas supply line for supplying into one of the processing chambers an oxidizing gas containing organic particles and inorganic particles; and an oxidizing gas supply valve for opening and closing the oxidizing gas supply line, wherein the control unit opens the oxidizing gas supply valve after closing the heated gas supply valve.

In accordance with a thirteenth aspect of the present invention, there is provided a particle detection helping apparatus for helping detection of organic particles by selectively expanding, among organic and inorganic particles causing defects of semiconductors in a semiconductor manufacturing process, the organic particles, the apparatus including: one or more processing chambers, each for accommodating a detection target object having organic and inorganic particles; an organic gas supply line for supplying an organic gas into one of the processing chambers; an organic gas supply valve for opening and closing the organic gas supply line; a heating lamp for irradiating heating light to the detection target object; and a control unit for controlling opening and closing of the organic gas supply valve and turning-on of the heating lamp so as to sequentially open the organic gas supply valve, close the organic gas supply valve and turn on the heating lamp in that order.

In accordance with a fourteenth aspect of the present invention, the particle detection helping apparatus described above further includes a UV lamp for irradiating UV rays to the detection target object, wherein the control unit turns on the UV lamp after turning off the heating lamp.

In accordance with a fifteenth aspect of the present invention, the particle detection helping apparatus described above further includes: an oxidizing gas supply line for supplying into one of the processing chambers an oxidizing gas for oxidizing the organic and the inorganic particles; and an oxidizing gas supply valve for opening and closing the oxidizing gas supply line, wherein the control unit opens the oxidizing gas supply valve after turning off the heating lamp.

In accordance with a sixteenth aspect of the present invention, there is provided a particle detection helping apparatus for helping detection of inorganic particles by selectively expanding, among organic and inorganic particles causing defects of semiconductors in a semiconductor manufacturing process, the inorganic particles, the apparatus including: a processing chamber for accommodating a detection target object having organic particles and inorganic particles; and a UV lamp for irradiating UV rays to the detection target object accommodated in the processing chamber.

In accordance with a seventeenth aspect of the present invention, there is provided a particle detection helping apparatus for helping detection of inorganic particles by selectively expanding, among organic and inorganic particles causing defects of semiconductors in a semiconductor manufacturing process, the inorganic particles, the apparatus including: a processing chamber for accommodating a detection target object having organic particles and inorganic particles; an oxidizing gas supply line for supplying into the processing chamber an oxidizing gas for oxidizing the organic and the inorganic particles; and an oxidizing gas supply valve for opening and closing the oxidizing gas supply line.

In accordance with an eighteenth aspect of the present invention, there is provided a particle detection system including one of the particle detection helping apparatuses described above and a particle detection apparatus for detecting organic or inorganic particles by irradiating light to the organic and the inorganic particles and receiving the light scattered by the organic and the inorganic particles.

In the first, the fourth, the fifth, the tenth, the thirteenth and the eighteenth aspect, the organic gas is brought into contact with the organic particles in the adsorption and infiltration step. The organic gas component contacted with the organic particles is adsorbed and infiltrated into the organic particles, so that the organic particles are foamed and expanded. The organic particles are heated in the next foaming step. For example, the organic particles are heated by bringing the heated gas into contact with the organic particles. Alternatively, the organic particles are heated by irradiating heating light to the organic particles in a nitrogen gas atmosphere. When the organic particles are heated, the organic gas component adsorbed and infiltrated into the organic particles serves as a foaming agent and, thus, the organic particles are further foamed and expanded. The organic particles that have been foamed and expanded in the foaming step are deformed and thus maintain the expanded size even after the organic gas component is volatilized by the light irradiation during the particle detection. Therefore, the organic particles do not shrink during light scattering detection, and this can help to make an accurate detection of the organic particles. Furthermore, since inorganic particles are not foamed and expanded, the organic particles can be selectively foamed and expanded.

Especially, in accordance with the particle detection helping apparatus of the tenth aspect, the control unit performs the above-described particle detection helping method by controlling opening and closing of the organic gas supply valve and the heated gas supply valve. First, the control unit introduces the organic gas into one of the processing chambers by opening the organic gas supply valve and brings the organic gas into contact with the organic particles of the detection target object in the processing chamber. Next, the control unit closes the organic gas supply valve and opens the heated gas supply valve to thereby introduce the heated gas into one of the processing chambers. Accordingly, the organic particles are further foamed and expanded.

Moreover, in accordance with the particle detection helping apparatus of the thirteenth aspect, the control unit performs the above-described particle detection helping method by controlling opening and closing of the organic gas supply valve and turn-on of the heating lamp. First, the control unit introduces the organic gas into one of the processing chambers by opening the organic gas supply valve and brings the organic gas into contact with the organic particles of the detection target object in the processing chamber. Next, the control unit closes the organic gas supply valve and turns on the heating lamp to thereby heat the organic gas. As a consequence, the organic particles are further foamed and expanded.

Further, in accordance with the particle detection method and the particle detection system of the fourth, the fifth and the eighteenth aspect, the foamed and expanded organic particles are irradiated with light and light scattered by the organic particles is received to thereby detect the organic particles. As described above, the organic particles do not shrink in spite of the light irradiation, and this enables effective detection of the organic particles.

Besides, the detection target object is not limited to a solid such as a semiconductor wafer and may also be a gas containing organic particles and inorganic particles.

In the sixth aspect, the temperature of the organic particles in the adsorption and infiltration step is lower than the boiling point of the organic gas. Thus, the organic gas component in a liquid state can be adsorbed and infiltrated into the organic particles, and the organic particles can be effectively foamed and expanded in the foaming step.

In the second, the seventh, the eleventh, the twelfth, the fourteenth, the fifteenth and the eighteenth aspect, the inorganic and the organic particles are oxidized in the oxidation step. Due to the oxidation, the organic particles are decomposed and the inorganic particles are expanded. Especially, in the particle detection apparatus of the eleventh and the fourteenth aspect, the control unit closes the heated gas supply valve and then turns on the UV lamp to thereby decompose the organic particles and oxidize and expand the inorganic particles. Moreover, in the particle detection apparatus of the twelfth and the fifteenth aspect, the control unit closes the heated gas supply valve and then opens the oxidizing gas supply valve to thereby introduce the oxidizing gas into one of the processing chambers and oxidize and expand the inorganic particles. The inorganic particles that have been expanded in the oxidation step are deformed and, thus, maintain the expanded size even after the light is irradiated to the inorganic particles during the particle detection. Therefore, the inorganic particles do not shrink during light scattering detection, and this can help accurate detection of the inorganic particles. Further, since the organic particles are decomposed by the oxidation, the inorganic particles can be selected and expanded.

Besides, in the particle detection method and the particle detection system of the seventh and the eighteenth aspect, the expanded inorganic particles are irradiated with light and light scattered by the inorganic particles is received to thereby detect the organic particles. As described above, the inorganic particles do not shrink in spite of the light irradiation, so that the inorganic particles can be detected effectively.

In the third, the eighth, the sixteenth, the seventeenth and the eighteenth aspect, the inorganic and the organic particles are oxidized in the oxidation step. Due to the oxidation, the organic particles are decomposed and the inorganic particles are expanded. Especially, in the particle detection helping apparatus of the sixteenth aspect, the control unit turns on the UV lamp so as to decompose the organic particles and expand the inorganic particles. Further, in the particle detection helping apparatus of the seventeenth aspect, the control unit opens the oxidizing gas supply valve to introduce the oxidizing gas into a processing chamber and expand the inorganic particles. The inorganic particles expanded in the oxidation step are deformed and, thus, maintain the expanded size even if light is irradiated thereto for particle detection. Therefore, the inorganic particles do not shrink during light scattering detection, and this can help to make an accurate detection of the inorganic particles. Further, the organic particles are decomposed by the oxidation reaction, so that the inorganic particles can be selected and expanded.

Besides, in the eighth and the eighteenth aspect, the expanded inorganic particles are irradiated with light and light scattered by the inorganic particles is received to thereby detect the inorganic particles. As described above, the inorganic particles do not shrink in spite of the light irradiation, so that the inorganic particles can be detected effectively.

In the ninth aspect, UV rays from the excimer lamp are irradiated to the inorganic particles in the atmosphere of the gaseous mixture of oxygen and nitrogen to thereby oxidize the inorganic particles. The UV rays have a high energy short wavelength of 172 nm and can generate oxygen radicals. Hence, the inorganic particles can be oxidized and expanded more effectively compared to the case of using an oxidation method using ozone gas or the like.

### EFFECTS OF THE INVENTION

In accordance with the first, the fourth, the fifth, the tenth, the thirteenth and the eighteenth aspect of the present invention, fine organic particle that could not be detected by a conventional light scattering method is foamed and expanded to have a detectable size, and this can help to make an accurate detection of organic particles. Further, fine organic particles that could not be detected by the conventional light scattering method can be detected accurately.

That is, it is possible to detect organic and inorganic particles smaller than or equal to 30 nm which could not be detected by employing the conventional light scattering method. Hence, a mass production yield of semiconductors can be easily increased.

In accordance with the sixth aspect of the present invention, fine organic particles can be detected by effectively foaming and expanding organic particles.

In accordance with the second, the seventh, the eleventh, the twelfth, the fourteenth, the fifteenth and the eighteenth aspect of the present invention, fine organic and inorganic particle that could not be detected by the conventional light scattering method are foamed and expanded, and oxidized and expanded to have detectable sizes, and this can help to make an accurate detection of the organic and the inorganic particles. Further, fine organic and inorganic particles that could not be detected by the conventional light scattering method can be accurately detected. Moreover, since the organic and the inorganic particles can be selectively expanded and detected, it is possible to determine whether the organic particles or the inorganic particles cause a decrease in mass production yield of semiconductors.

In accordance with the third, the eighth, the sixteenth, the seventeenth and the eighteenth aspect of the present invention, fine inorganic particles that could not be detected by the conventional light scattering method are oxidized and expanded to have detectable sizes, and this can help to make an accurate detection of the inorganic particles. Further, fine organic particles that could not be detected by the conventional light scattering method can be detected accurately.

In accordance with the ninth aspect of the present invention, fine inorganic particles are detected by effectively oxidizing and expanding inorganic particles.

### BRIEF DESCRIPTION OF THE DRAWINGS

FIG. 1 is a top view schematically showing a particle detection system in accordance with a first embodiment of the present invention;

FIG. 2 provides a block diagram illustrating a configuration of the particle detection system;

FIG. 3 depicts a flowchart showing a processing sequence of a control unit in accordance with the first embodiment of the present invention;

FIGS. 4A to 4D offer explanatory diagrams conceptually illustrating an organic particle detection helping method and an organic particle detection method;

FIGS. 5A to 5C are explanatory diagrams conceptually describing an inorganic particle detection helping method and an inorganic particle detection method;

FIG. 6 presents a top view schematically showing a particle detection system in accordance with a second embodiment of the present invention;

FIG. 7 represents a flowchart showing a processing sequence of a control unit in accordance with the second embodiment of the present invention;

FIG. 8 sets forth a top view schematically depicting a particle detection system in accordance with a third embodiment of the present invention; and

FIG. 9 is a flowchart illustrating a processing sequence of a control unit in accordance with the third embodiment of the present invention.

### DETAILED DESCRIPTION OF THE EMBODIMENTS

Hereinafter, embodiments of the present invention will be described in detail with reference to the accompanying drawings.

### First Embodiment

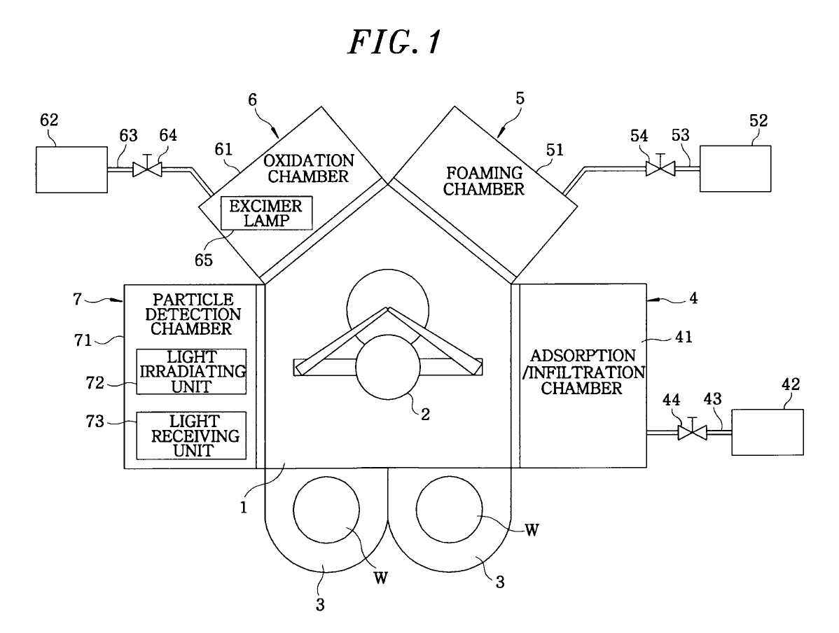

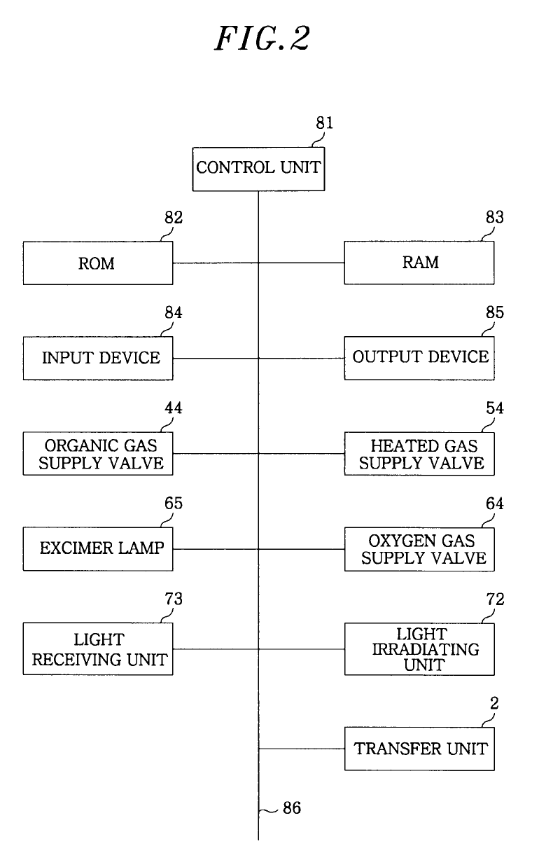

FIG. 1 is a top view schematically showing a particle detection system in accordance with a first embodiment of the present invention, and FIG. 2 provides a block diagram illustrating a configuration of the particle detection system. A particle detection system in accordance with the present invention is a device for detecting fine organic particles P1 and fine inorganic particles P2 (having a diameter smaller than or equal to 30 nm) adhered to a detection target object W, e.g., a semiconductor wafer, and carries out a particle detection helping method and a particle detection method in accordance with the first embodiment of the present invention. The particle detection system includes a processing chamber 1 where a transfer unit for transferring the detection target object W is installed. Provided around the transfer chamber 1 are a detection target object accommodating chamber 3, an adsorption and infiltration chamber 4, a foaming chamber 5, an oxidation chamber 6, and a particle detection chamber 7.

The adsorption and infiltration chamber 4 has a processing chamber 41 and an organic gas supply unit 42 for supplying into the processing chamber 41 an organic gas, e.g., a hydrocarbon-based gas such as butane, pentane, alcohol, acetone, xylene or the like. The processing chamber 41 and the organic gas supply unit 42 are connected to each other by an organic gas supply line 43, and an organic gas is supplied from the organic gas supply unit 42 into the processing chamber 41 through the organic gas supply line 43. The organic gas supply line 43 is provided with an organic gas supply valve 44 for opening and closing the organic gas supply line 43. The organic gas supply valve 44 is, e.g., an electromagnetic valve.

The foaming chamber 5 has a processing chamber 51 and a heated gas supply unit 52 for supplying into the processing chamber 51 a heated gas, e.g., high-temperature steam of 100° C. or above. Further, the heated gas does not include any gas that heats and oxidizes the organic particles P1. The processing chamber 51 and the heated gas supply unit 52 are connected to each other by a heated gas supply line 53, and the heated gas is supplied from the heated gas supply unit 52 into the processing chamber 51 through the heated gas supply line 53. The heated gas supply line 53 is provided with a heated gas supply valve 54 for opening and closing the heated gas supply line 53. The heated gas supply valve 54 is, e.g., an electromagnetic valve.

The oxidation chamber 6 has a processing chamber 61, an excimer lamp 65 provided at an inner ceiling portion of the processing chamber 61 and an oxygen gas supply unit 62 for supplying a gaseous mixture of oxygen and nitrogen into the processing chamber 61. The excimer lamp 65 is a UV (Ultraviolet) lamp capable of irradiating UV rays of a short wavelength of 172 nm of high energy (7.2 eV). The processing chamber 61 and the oxygen gas supply unit 62 are connected to each other by an oxygen gas supply line 63, and the gaseous mixture of oxygen and nitrogen is supplied from the oxygen gas supply unit 62 into the processing chamber 61 through the oxygen gas supply line 63. The oxygen gas supply line 63 is provided with an oxygen gas supply valve for opening and closing the oxygen gas supply line 63. The oxygen gas supply valve 64 is, e.g., an electromagnetic valve.

The particle detection chamber 7 has a processing chamber 71, a light irradiating unit 72 provided in the processing chamber 71 and a light receiving unit 73 for receiving the light scattered by the organic particles P1 and the inorganic particles P2 adhered to the detection target object W.

In addition, the particle detection system includes a control unit 81 for controlling the transfer unit 2, the organic gas supply valve 44, the heated gas supply valve 54 and the like. The control unit 81 is, e.g., a CPU of a microcomputer, and is connected via a bus 86 to a ROM 82, a RAM 83, an input device 84 and an output device 85. The ROM 82 is a nonvolatile memory such as a mask ROM, EEPROM or the like which stores a control program required for an operation of the computer. The RAM 83 is a volatile memory such as a DRAM, an SRAM or the like which temporarily stores various data generated when the control unit 81 performs operation. The input device 84 is an input button, a keyboard or the like which receives user's manipulation of the particle detection system. The output device 85 is a display device for outputting a particle detection result.

Further, the control unit 81 is connected via an interface (not shown) to the organic gas supply valve 44, the heated gas supply valve 54, the excimer lamp 65, the oxygen gas supply valve 64, the light irradiating unit 72, the light receiving unit 73 and the transfer unit 2. The control unit 81 is configured to control an operation of each unit by sending a control signal.

Moreover, the adsorption and infiltration chamber 4, the foaming chamber 5, the oxidation chamber 6 and the transfer unit 2 form a particle detection helping apparatus for performing the particle detection helping method of the present invention.

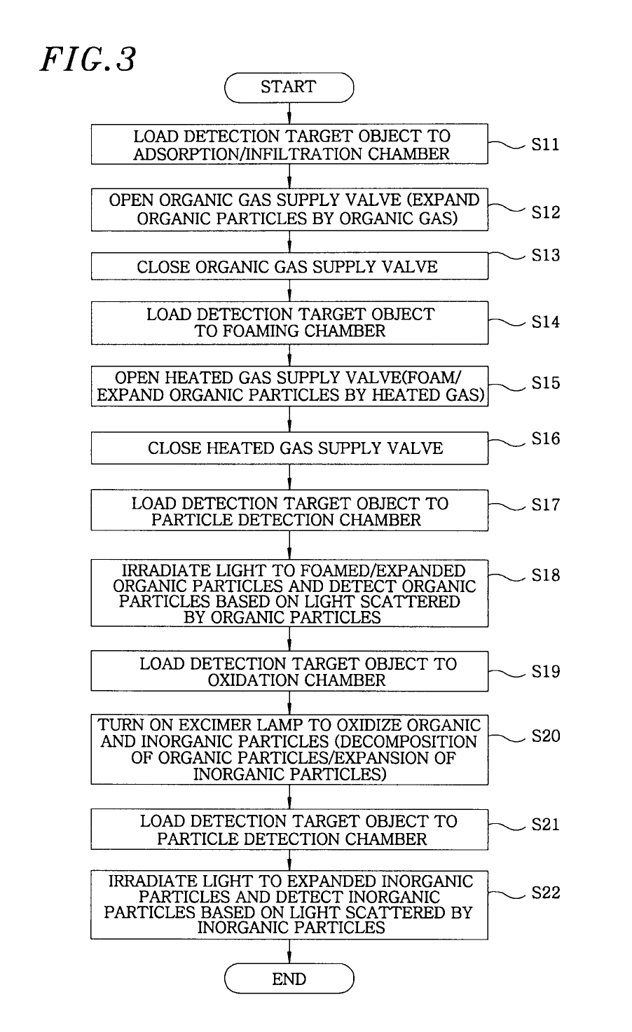

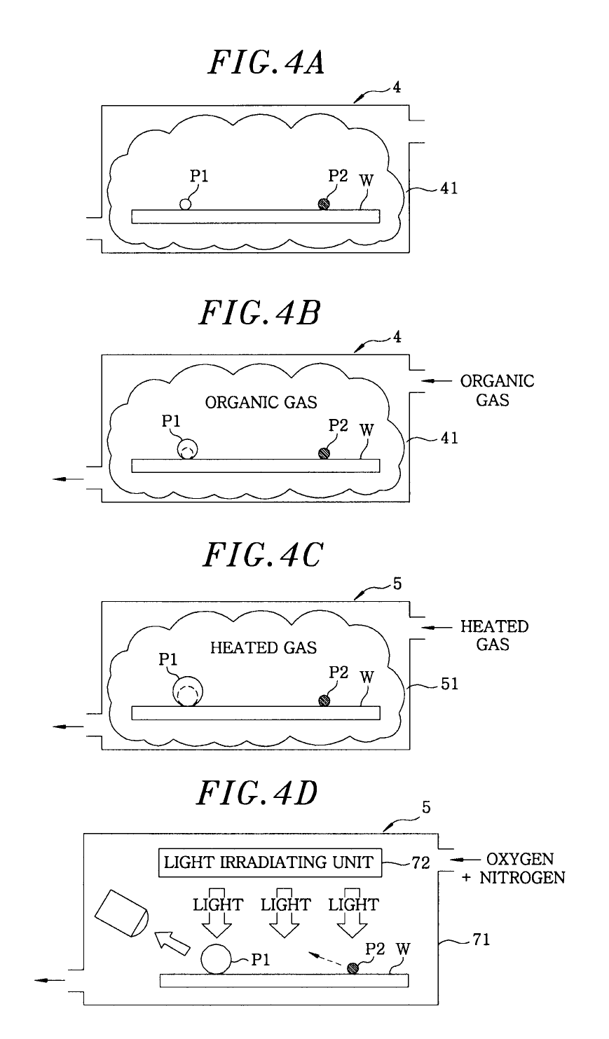

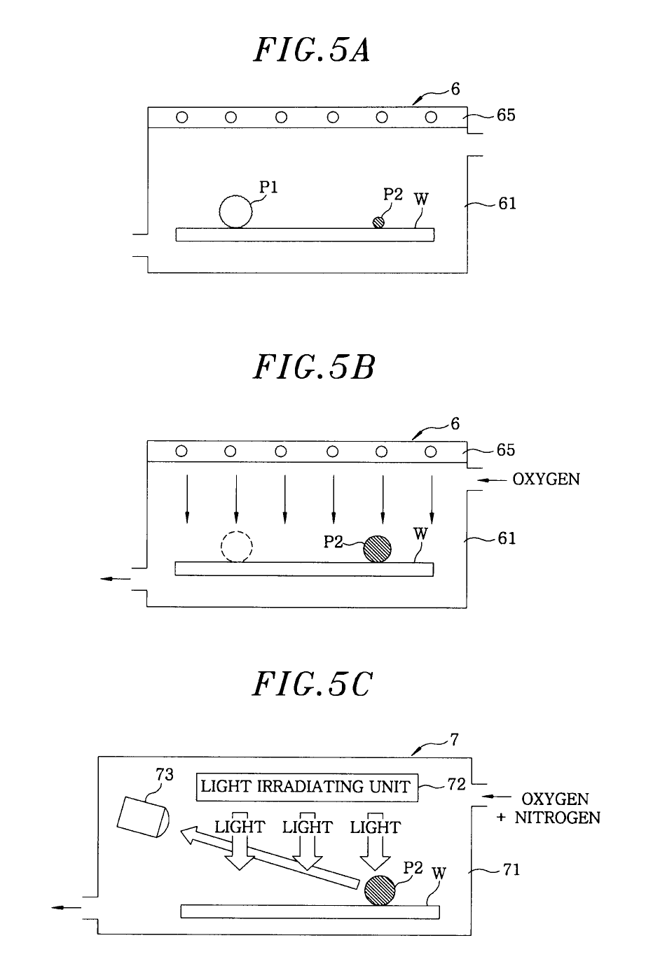

FIG. 3 depicts a flowchart showing a processing sequence of the control unit 81 in accordance with the first embodiment of the present invention. FIGS. 4A to 4D offer explanatory diagrams conceptually illustrating a particle detection helping method and a particle detection method for the organic particles P1. FIGS. 5A to 5C are explanatory diagrams conceptually describing a particle detection helping method and a particle detection method for the inorganic particles P2.

Particle detection can be started by a user's instruction inputted through the input device 84, and the control unit 81 receives the start instruction of the particle detection. When the start instruction of the particle detection is received from the input device 84, the control unit 81 reads out a computer program related to a particle detection process and a particle detection helping process stored in the ROM 82 and loads the computer program onto the RAM 83, thereby performing following processes. First, the control unit 81 controls an operation of the transfer unit 2 to load the detection target object W to the adsorption and infiltration chamber 4 as shown in FIG. 4A (step S11).

Next, the control unit 81 opens the organic gas supply valve (step S12). When the organic gas supply valve 44 is opened, the organic gas is supplied into the processing chamber 41. The organic gas supplied into the processing chamber 41 is brought into contact with organic particles P1 and adsorbed and infiltrated into the organic particles P1. Thus, the organic particles P1 are expanded as depicted in FIG. 4B.

Preferably, a type of an organic gas is selected or a temperature of the detection target object W is controlled so that the temperature of the detection target object W becomes lower than a boiling point of the organic gas. If the temperature of the detection target object W is lower than the boiling point of the organic gas, the organic gas is effectively adsorbed and infiltrated into the organic particles P1. Accordingly, the organic particles P1 are expanded.

When a predetermined period of time elapses after the organic gas supply valve 44 is opened, the control unit 81 closes the organic gas supply valve 44 (step S13). Next, the control unit 81 controls the operation of the transfer unit 2 to load the detection target object W from the adsorption and infiltration chamber 4 into the foaming chamber 5 (step S14).

Then, the control unit 81 opens the heated gas supply valve 54 (step S15). When the heated gas supply valve 54 is opened, the heated gas is supplied into the processing chamber 51. The heated gas supplied into the processing chamber 51 is brought into contact with the organic particles P1 and heats the organic particles P1. The heated organic particles P1 are softened and also foamed and expanded as illustrated in FIG. 4C.

When a predetermined period of time elapses after the heated gas supply valve 54 is opened, the control unit 81 closes the heated gas supply valve 54 (step S16). Next, the control unit 81 controls an operation of the transfer unit 2 to load the detection target object W from the foaming chamber 5 into the particle detection chamber 7 (step S17).

Next, as shown in FIG. 4D, the light irradiating unit 72 is turned on by the control unit 81 to irradiate light to the foamed and expanded organic particles P1, and the light scattered by the organic particles P1 is received by the light receiving unit 73. The organic particles P1 are detected based on the intensity of the received light (step S18).

Thereafter, the control unit 81 controls the operation of the transfer unit 2 to load the detection target object W from the particle detection chamber 7 into the oxidation chamber 6 as shown in FIG. 5A (step S19).

Then, the control unit 81 turns on the excimer lamp 65 while supplying a gaseous mixture of oxygen and nitrogen by opening the oxygen gas supply valve 63, thereby oxidizing the organic particles P1 and the inorganic particle P2 adhered to the detection target object W (step S20). Due to UV rays from the excimer lamp 65, oxygen in the processing chamber 61 becomes ozone and oxygen radicals, and the organic particles P1 and the inorganic particles P2 are oxidized. As a result of the oxidation reaction, the organic particles P1 are decomposed and the inorganic particles P2 are expanded, as can be seen from FIG. 5B.

A preferable concentration of oxygen supplied into the processing chamber 61 is a few %. This is because when the oxygen concentration is too high, the UV rays are adsorbed into oxygen, and this disturbs effective oxidation of the organic particles P1 and the inorganic particles P2.

Moreover, the control unit 81 controls the operation of the transfer unit 2 to load the detection target object W from the oxidation chamber 6 into the particle detection chamber 7 (step S21).

Then, as shown in FIG. 5C, the light irradiating unit 72 is turned on by the control unit 81 to irradiate light to the expanded inorganic particles P2, and the light scattered by the inorganic particles P2 is received by the light receiving unit 73. The inorganic particles P2 are detected based on the intensity of the received light (step S22), and the process is completed.

In an application of the particle detection helping method, the particle detection method, the particle detection helping apparatus or the particle detection system in accordance with the first embodiment of the present invention, fine organic particles P1 and fine inorganic particles P2 which could not be detected by the conventional light scattering method can be expanded to have detectable sizes, and this can help the detection of the organic particles P1 and the inorganic particles P2.

Further, since the foamed and expanded organic particles P1 and the oxidized and expanded inorganic particles P2 are deformed, the organic particles P1 and the inorganic particles P2 do not shrink even if the light for particle detection is irradiated. This can help to make the accurate detection of the particles P1 and P2.

Further, by expanding the organic and the inorganic particles P1 and P2 as described above, it is possible to accurately detect fine organic and inorganic particles P1 and P2 smaller than or equal to 30 nm which could not be detected by the conventional light scattering method. Hence, the mass production yield of semiconductors can be easily increased.

Furthermore, the organic particles P1 and the inorganic particles P2 are selectively expanded and detected. Therefore, fine organic particles P1 and fine organic particles P2 can be selectively detected.

In addition, when the temperature of the organic particles P1 is set to be lower than that of the organic gas, the organic particles P1 are effectively foamed and expanded, which enables detection of finer organic particles P1.

Besides, the organic particles P1 and the inorganic particles P2 are oxidized by UV rays from the excimer lamp 65. Accordingly, the inorganic particles P2 can be effectively expanded by radicals, and finer inorganic particles P2 can be accurately detected.

In the first embodiment, the adsorption and infiltration chamber, the foaming chamber, the oxidation chamber and the particle detection chamber are separately provided. However, a single processing chamber may serve as each of the above chambers. The particle detection process and the particle detection helping process may be carried out in the single processing chamber.

Although a semiconductor wafer has been described as an example of the detection target object, the present invention may be applied to the case where a gas containing organic particles and inorganic particles is used as the detection target object.

Moreover, although the example in which organic particles and inorganic particles are detected by a light scattering method is described in the first embodiment, the expanded particles may be detected by an SEM (Scanning Electron Microscope) or by other devices.

### Second Embodiment

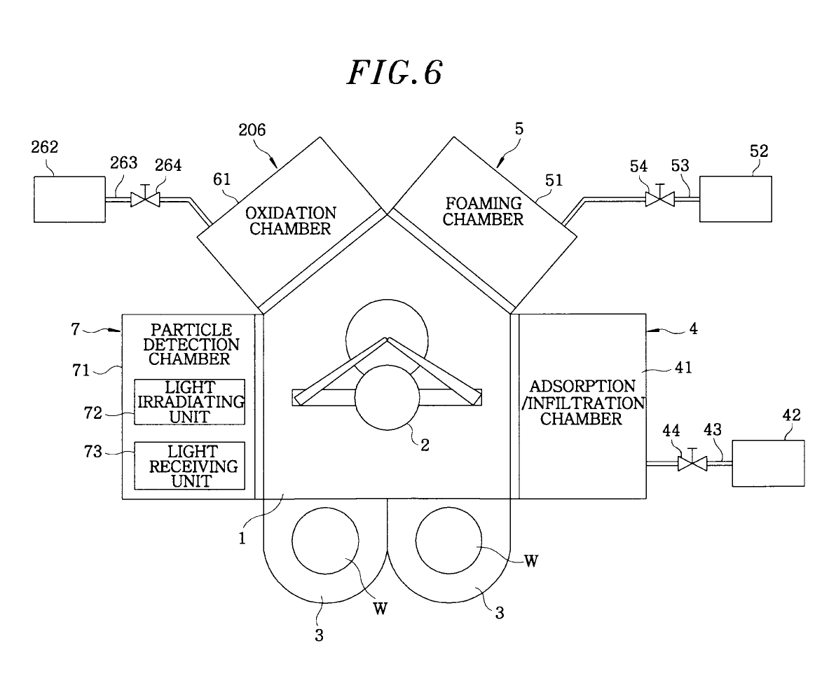

FIG. 6 presents a top view schematically showing a particle detection system in accordance with a second embodiment of the present invention. As in the particle detection system in accordance with the first embodiment, the particle detection system in accordance with the second embodiment includes the transfer chamber 1, the transfer unit 2, the detection target object accommodating chamber 3, the adsorption and infiltration chamber 4, the foaming chamber 5, an oxidation chamber 206, the particle detection chamber 7 and the control unit 81. However, the particle detection system of the second embodiment is different from that of the first embodiment in the structure of the oxidation chamber 7 and the processing sequence of the control unit 81. Thus, the differences will be described only hereinafter.

The oxidation chamber 206 has a processing chamber 61 and an oxidizing gas supply unit 262 for supplying into the processing chamber 61 an oxidizing gas, e.g., ozone gas.

The processing chamber 61 and the oxidizing gas supply unit 262 are connected to each other by an oxidizing gas supply line 263, and an oxidizing gas is supplied from the oxidizing gas supply unit 262 into the processing chamber 61 through the oxidizing gas supply line 263. The oxidizing gas supply line 263 is provided with an oxidizing gas supply valve 264 for opening and closing the organic gas supply line 263. The organic gas supply valve 264 is, e.g., an electromagnetic valve.

As in the first embodiment, the control unit 81 is connected via an interface (not shown) to the ROM 82, the RAM 83, the input device 84, the output device 85, the organic gas supply valve 44, the heated gas supply valve 54, the light irradiating unit 72, the light receiving unit 73 and the transfer unit 2. Further, the control unit 81 is connected to the oxidizing gas supply valve 264 instead of the excimer lamp 65 and the oxidizing gas supply valve 64 in the first embodiment.

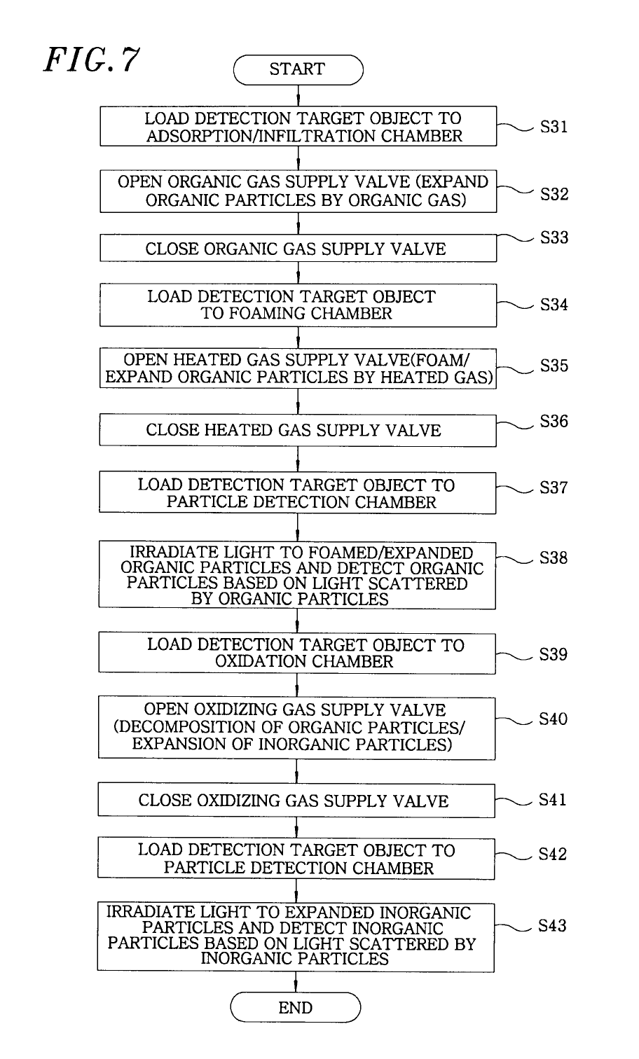

FIG. 7 represents a flow chart showing a processing sequence of the control unit 81 in accordance with the second embodiment of the present invention. The control unit 81 executes, in steps S31 to S39, the processing of the steps S11 to S19 for foaming, expanding and detecting the organic particles P1 which have been described in the first embodiment.

Then, the control unit 81 opens the oxidizing gas supply valve 264 (step S40). When the oxidizing gas supply valve 264 is opened, the oxidizing gas is supplied into the processing chamber 61. The oxidizing gas supplied into the processing chamber 61 is brought into the organic particles P1 and the inorganic particles P2 and oxidizes the particles P1 and P2. Due to the oxidation reaction, the organic particles P1 are decomposed and the inorganic particles P2 are expanded.

When a predetermined period of time elapses after the oxidizing gas supply valve 264 is opened, the control unit closes the oxidizing gas supply valve 264 (step S41). Next, the control unit 81 executes, in steps S42 and S43, the processing of the steps S21 and S22 for detecting the inorganic particles P2 which have been described in the first embodiment.

The particle detection helping method, the particle detection method, the particle detection helping apparatus and the particle detection system in accordance with the second embodiment can provide the similar effects of the first embodiment.

The other configurations, operations and effects of the particle detection system of the second embodiment are similar to those of the particle detection system of the first embodiment. Therefore, like reference numerals will be used for like parts, and detailed description thereof will be omitted.

### Third Embodiment

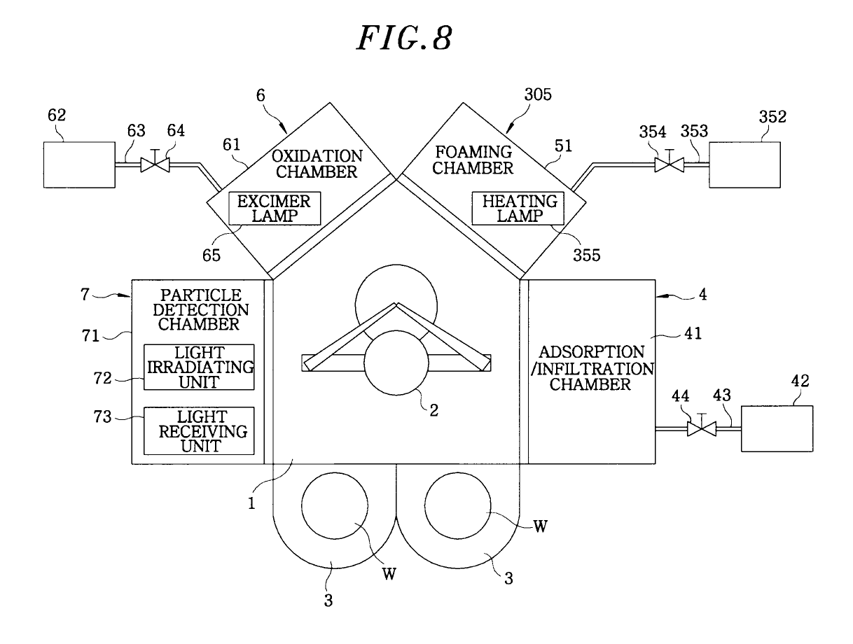

FIG. 8 sets forth a top view schematically depicting a particle detection system in accordance with a third embodiment of the present invention. As in the particle detection system in accordance with the first embodiment, the particle detection system in accordance with the third embodiment includes the transfer chamber 1, the transfer unit 2, the detection target object accommodating chamber 3, the adsorption and infiltration chamber 4, a foaming chamber 305, the oxidation chamber 6, the particle detection chamber 7 and the control unit 81. The particle detection system of the third embodiment is different from that of the first embodiment in the structure of the foaming chamber 305 and the processing sequence of the control unit 81. Thus, only the differences will be described only hereinafter.

The foaming chamber 305 has a processing chamber 51, a heating lamp 355 provided at an inner ceiling portion of the processing chamber 51 and a nitrogen gas supply unit 352 for supplying a nitrogen gas into the processing chamber 51. The heating lamp 355 is an infrared lamp for irradiating infrared rays (heating light) for heating the organic particles P1 in a nitrogen gas atmosphere, a UV lamp for irradiating UV rays (heating light) which do not decompose the organic particles P1, or the like. The processing chamber 51 and the nitrogen gas supply unit 352 are connected to each other by a nitrogen gas supply line 353, and a nitrogen gas is supplied from the nitrogen gas supply unit 352 into the processing chamber 51 through the nitrogen gas supply line 353. The nitrogen gas supply line 353 is provided with a nitrogen gas supply valve 354 for opening and closing the nitrogen gas supply line 353. The nitrogen gas supply valve 354 is, e.g., an electromagnetic valve.

As in the first embodiment, the control unit 81 is connected via an interface (not shown) to the ROM 82, the RAM 83, the input device 84, the output device 85, the organic gas supply valve 44, the excimer lamp 65, the oxygen gas supply valve 64, the light irradiating unit 72, the light receiving unit 73 and the transfer unit 2. Further, the control unit 81 is connected to the nitrogen gas supply valve 354 and the heating lamp 355 instead of the gas supply valve 54 in the first embodiment.

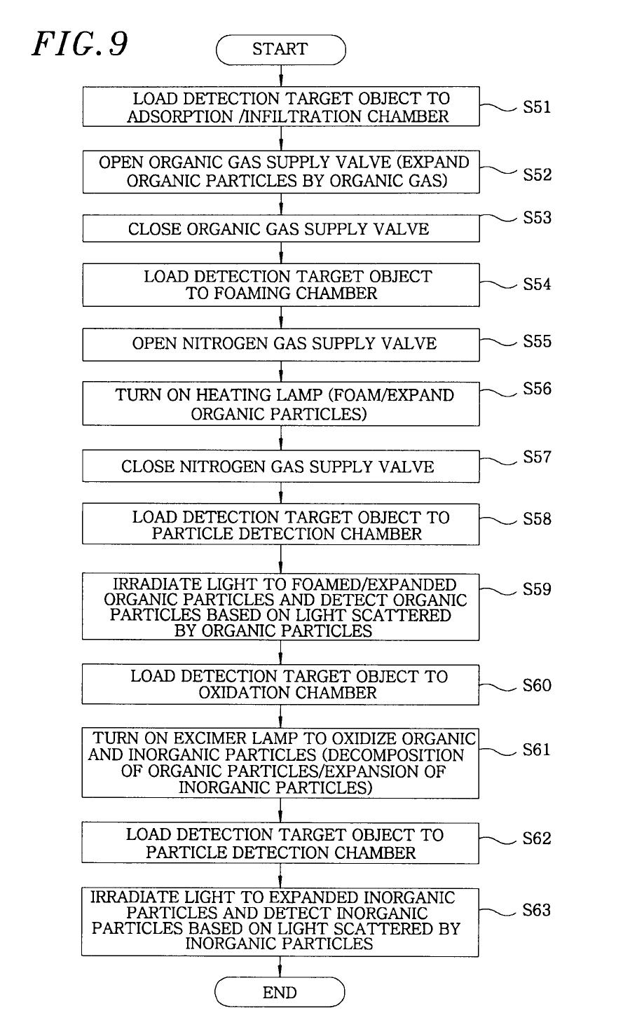

FIG. 9 is a flowchart illustrating a processing sequence of the control unit 81 in accordance with the third embodiment of the present invention. The control unit 81 executes, in steps S51 to S54, the processing of the steps S11 to S14 for expanding the organic particles P1 which have been described in the first embodiment.

Then, the control unit 81 opens the nitrogen gas supply valve 354 (step S55). When the nitrogen gas supply valve 354 is opened, the nitrogen gas is supplied into the processing chamber 51. Thereafter, the control unit 81 turns on the heating lamp 355 (step S56). When the heating light is irradiated to the organic particles P1 in a nitrogen gas atmosphere, the organic particles P1 are heated. The heated organic particles P1 are softened and also foamed and expanded.

When a predetermined period of time elapses after the heating lamp 355 is turned on, the control unit 81 turns off the heating lamp 355 and closes the nitrogen gas supply valve 354 (step S57). Next, the control unit 81 executes, in steps S58 and S63, the processing of the steps S17 to S22 for detecting the organic and the inorganic particles P1 and P2 which have been described in the first embodiment.

The particle detection helping method, the particle detection method, the particle detection helping apparatus and the particle detection system in accordance with the third embodiment can provide the similar effects of the first embodiment.

In addition, the effects of the first embodiment can also be obtained by applying the configuration of the heating lamp of the third embodiment to the second embodiment.

The other configurations, operations and effects of the particle detection system of the third embodiment are similar to those of the particle detection system of the first embodiment. Therefore, like reference numerals will be used for like parts, and the detailed description thereof will be omitted.

The above-described embodiments are illustrative in all aspects, and do not limit the present invention. While the invention has been shown and described with respect to the embodiments, various changes and modification may be made without departing from the scope of the invention as defined in the following claims.

1-9. (canceled)

10. A particle detection helping apparatus for helping detection of organic particles by selectively expanding, among organic and inorganic particles causing defects of semiconductors in a semiconductor manufacturing process, the organic particles, the apparatus comprising:
one or more processing chambers each for accommodating a detection target object having organic and inorganic particles;
an organic gas supply line for supplying an organic gas into one of the processing chambers;
an organic gas supply valve for opening and closing the organic gas supply line;
a heated gas supply line for supplying a heated gas into one of the processing chambers;
a heated gas supply valve for opening and closing the heated gas supply line; and
a control unit for controlling opening and closing of the organic gas supply valve and the heated gas supply valve so as to sequentially open the organic gas supply valve, close the organic gas supply valve and open the heated gas supply valve in that order.

11. The particle detection helping apparatus of claim 10, further comprising a UV lamp for irradiating UV rays to the detection target object, wherein the control unit turns on the UV lamp after closing the heated gas supply valve.

12. The particle detection helping apparatus of claim 10, further comprising:
an oxidizing gas supply line for supplying into one of the processing chambers an oxidizing gas containing organic particles and inorganic particles; and
an oxidizing gas supply valve for opening and closing the oxidizing gas supply line,
wherein the control unit opens the oxidizing gas supply valve after closing the heated gas supply valve.

13. A particle detection helping apparatus for helping detection of organic particles by selectively expanding, among organic and inorganic particles causing defects of semiconductors in a semiconductor manufacturing process, the organic particles, the apparatus comprising:
one or more processing chambers each for accommodating a detection target object having organic and inorganic particles;
an organic gas supply line for supplying an organic gas into one of the processing chambers;
an organic gas supply valve for opening and closing the organic gas supply line;
a heating lamp for irradiating heating light to the detection target object; and
a control unit for controlling opening and closing of the organic gas supply valve and turning-on of the heating lamp so as to sequentially open the organic gas supply valve, close the organic gas supply valve and turn on the heating lamp in that order.

14. The particle detection helping apparatus of claim 13, further comprising a UV lamp for irradiating UV rays to the detection target object, wherein the control unit turns on the UV lamp after turning off the heating lamp.

15. The particle detection helping apparatus of claim 13, further comprising:
an oxidizing gas supply line for supplying into one of the processing chambers an oxidizing gas for oxidizing the organic and the inorganic particles; and
an oxidizing gas supply valve for opening and closing the oxidizing gas supply line,
wherein the control unit opens the oxidizing gas supply valve after turning off the heating lamp.

16. A particle detection helping apparatus for helping detection of inorganic particles by selectively expanding, among organic and inorganic particles causing defects of semiconductors in a semiconductor manufacturing process, the inorganic particles, the apparatus comprising:
a processing chamber for accommodating a detection target object having organic particles and inorganic particles; and
a UV lamp for irradiating UV rays to the detection target object accommodated in the processing chamber.

17. A particle detection helping apparatus for helping detection of inorganic particles by selectively expanding, among organic and inorganic particles causing defects of semiconductors in a semiconductor manufacturing process, the inorganic particles, the apparatus comprising:
a processing chamber for accommodating a detection target object having organic particles and inorganic particles;
an oxidizing gas supply line for supplying into the processing chamber an oxidizing gas for oxidizing the organic and the inorganic particles; and
an oxidizing gas supply valve for opening and closing the oxidizing gas supply line.

18. A particle detection system comprising:
the particle detection helping apparatus described in claim 10;
and a particle detection apparatus for detecting organic or inorganic particles by irradiating light to the organic and the inorganic particles and receiving the light scattered by the organic and the inorganic particles.

19. A particle detection system comprising:
the particle detection helping apparatus described in claim 11;
and a particle detection apparatus for detecting organic or inorganic particles by irradiating light to the organic and the inorganic particles and receiving the light scattered by the organic and the inorganic particles.

20. A particle detection system comprising:
the particle detection helping apparatus described in claim 12;
and a particle detection apparatus for detecting organic or inorganic particles by irradiating light to the organic and the inorganic particles and receiving the light scattered by the organic and the inorganic particles.

21. A particle detection system comprising:
the particle detection helping apparatus described in claim 13;
and a particle detection apparatus for detecting organic or inorganic particles by irradiating light to the organic and the inorganic particles and receiving the light scattered by the organic and the inorganic particles.

22. A particle detection system comprising:
the particle detection helping apparatus described in claim 14;
and a particle detection apparatus for detecting organic or inorganic particles by irradiating light to the organic and the inorganic particles and receiving the light scattered by the organic and the inorganic particles.

23. A particle detection system comprising:
the particle detection helping apparatus described in claim 15;
and a particle detection apparatus for detecting organic or inorganic particles by irradiating light to the organic and the inorganic particles and receiving the light scattered by the organic and the inorganic particles.

24. A particle detection system comprising:
the particle detection helping apparatus described in claim 16;
and a particle detection apparatus for detecting organic or inorganic particles by irradiating light to the organic and the inorganic particles and receiving the light scattered by the organic and the inorganic particles.

25. A particle detection system comprising:
the particle detection helping apparatus described in claim 17;
and a particle detection apparatus for detecting organic or inorganic particles by irradiating light to the organic and the inorganic particles and receiving the light scattered by the organic and the inorganic particles.
